(19) United States
(12) Patent Application Publication
(10) Pub. No.: US 2010/0307348 A1
(43) Pub. Date: Dec. 9, 2010

(54) DISTRIBUTOR FOR GROUND COFFEE DISPENSERS

(76) Inventor: Guillermo Balmont Arroyo, Barcelona (ES)

Correspondence Address: OSTROLENK FABER GERB & SOFFEN, 1180 AVENUE OF THE AMERICAS, NEW YORK, NY, 100368403, US

(21) Appl. No.: 12/797,237

(22) Filed: Jun. 9, 2010

(30) Foreign Application Priority Data
Jun. 9, 2009 (ES) U200930171

(51) Int. Cl. A47J 42/50; B67D 7/06

(52) U.S. Cl. 99/537; 222/508

(57) ABSTRACT

The invention relates to a distributor for ground coffee dispensers comprising a swinging trapdoor for the temporary retention of the dispensed amount of ground coffee inside an outlet duct, an actuator element associated with the rotating shaft of the swinging trapdoor and able to rotate between two angular end positions, and a motor conveying to said actuator element a rotating movement with a determined amplitude by means of a wheel and a belt; and wherein said actuator element has a configuration in the form of a circular sector the rotating shaft of which is located in correspondence with a point of the bisector close to the angle or vertex of said circular sector; the curved profile of the actuator element forming a support surface for supporting the belt for conveying the rotating movement of the motor and the rotation of the actuator element towards one of the angular end positions being determined.

### CROSS REFERENCE TO RELATED APPLICATION

This application claims the benefit under 35 U.S.C. § 119 of Spanish Patent Application No. U200930171, filed Jun. 9, 2009, the contents of which are specifically incorporated by reference herein.

### OBJECT OF THE INVENTION

The present invention relates to a distributor for ground coffee dispensers, especially designed for being applied in ground coffee dispensers located at the outlet of coffee grinders for the purpose of achieving an automatic dispensing of ground coffee in different amounts and/or in different outlets.

### BACKGROUND OF THE INVENTION

The coffee grinders associated in industrial coffee makers, vending machines, etc., have dispensers with at least one outlet duct or chamber to which the dispensed amount of ground coffee has access by gravity, said chamber or duct having one or several distributors which allow temporarily retaining the dispensed amount of coffee for supplying it at the precise moment as the previously supplied dispensed amounts of coffee are gradually consumed.

In some cases these grinders have two outlet ducts or chambers converging in the upper part in an inlet duct for the ground coffee coming from the grinder, having in the mentioned convergence area a distributor which diverts the ground coffee towards either outlet duct as the dispensed amounts of ground coffee contained therein are gradually supplied.

Dispensers and distributors of this type are described, for example, in patents ES2 212 683B1, EP 0434612 and EP 0818170.

The mentioned distributors typically comprise a swinging trapdoor between two end positions, said trapdoor being fixed to a wheel linked by means of a belt with a wheel associated with a drive element. This motor is in charge of conveying to the trapdoor an alternating rotating movement by means of the mentioned wheels and belt, arranging said trapdoor at any of the end positions for the purpose of correctly dispensing the successive dispensed amounts of ground coffee.

In distributors of this type, the positioning of the trapdoor is determined exclusively by the rotation of the motor, the position of the trapdoor being changed rapidly. During the continued use of the distributor, it is common for slight mismatches to occur and for the trapdoor to experience a slight backlash movement upon reaching the end positions and colliding against the walls of the dispenser, which prevents its stable positioning in the closed position, with the subsequent loss and unwanted falling of part of the dispensed amount of ground coffee to be retained.

Therefore, the technical problem that is considered is the development of a distributor in which the trapdoor operating means prevent the mentioned backlash effect and obtaining a defective closure, assuring the effective retention of said trapdoor in any of the end positions and eliminating the problem involved with the uncontrolled falling or loss of the ground coffee when said trapdoor is in an end closed position.

### DESCRIPTION OF THE INVENTION

The distributor object of the invention, being of the type of those mentioned above, i.e., which comprise: a swinging trapdoor for the temporary retention of the dispensed amount of ground coffee inside a discharge duct, or the deviation of the dispensed amount of ground coffee towards two alternative discharge ducts, an actuator element associated with the rotating shaft of the swinging trapdoor and able to rotate between two angular end positions of the swinging trapdoor, and a drive motor conveying a rotating movement, with a determined amplitude, to the mentioned actuator element by means of a wheel and a belt or element for conveying the movement; has very simple constructive particularities which allow assuring the effective arrangement of the trapdoor in either of the end positions.

To that end and according to the invention, the actuator element associated with the trapdoor has a configuration in the form of a circular sector having an amplitude equal to or less than 180°, the rotating shaft of which is located in correspondence with a point of the bisector close to the angle or vertex of said circular sector, the curved profile of the actuator element forming a support surface for supporting the belt for conveying the rotating movement of the motor.

With this configuration, the rotation of the actuator element towards any one of the angular end positions determines a variation of the distances existing between the mid-plane of the distributor, defined by the rotating shafts of the actuator element and of the wheel of the motor, and the respective end support areas for supporting the belt on the actuator element, such that the tension of the belt on said end support areas causes respective rotation torques, of opposite directions and different magnitudes, to be applied on the actuator element, resulting in a rotation torque which tends to keep the actuator element in the chosen end position.

It should be mentioned that with the mentioned configuration of the actuator element the antagonistic rotation torques caused by the tension of the belt are only balanced when the actuator element is in an angular intermediate position of its travel, which occurs exclusively when said actuator element changes position.

In the moment in which the actuator element goes from said angular intermediate position towards any of the end positions, the mentioned rotation torques become unbalanced, the resulting torque tending to cause the shifting of the actuator element in the same operating direction, and to keep the actuator element in the corresponding end position, up to the point that if the attempt is made to slightly shift the actuator element in the opposition direction, it returns towards the mentioned end position.

Therefore, the solution proposed in the invention assures the stable positioning of the actuator element in the chosen end position, preventing leaks or losses of ground coffee when said end position is a closed position.

In an embodiment of the invention the belt for conveying the rotating movement is formed from an elastic material to improve its interaction with the actuator element.

### DESCRIPTION OF THE DRAWINGS

To complement the description that is being made and for the purpose of better understanding the features of the invention, a set of drawings is attached to present specification in which the following has been depicted with an illustrative and non-limiting character:

FIG. 1 shows a front elevational view of an embodiment of the distributor of the invention, in which the trapdoor and actuator element have been depicted with a solid line in a first end position, and with a dotted line in a second end position, opposite the first.

FIG. 2 shows a schematic view of several units of the distributor of the invention applied in a known ground coffee dispenser.

FIG. 3 shows an elevational view of the distributor in a first end position.

FIG. 4 shows an elevational view of the distributor in a second end position.

FIG. 5 shows a perspective view of the assembly formed by the actuator element, the trapdoor and the rotating shaft which establishes their attachment.

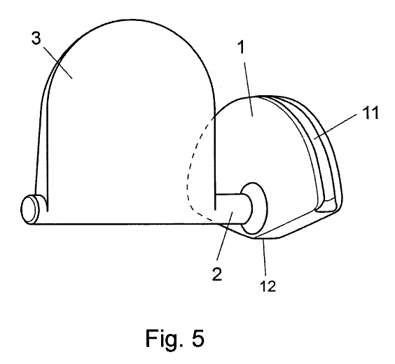

### PREFERRED EMBODIMENT OF THE INVENTION

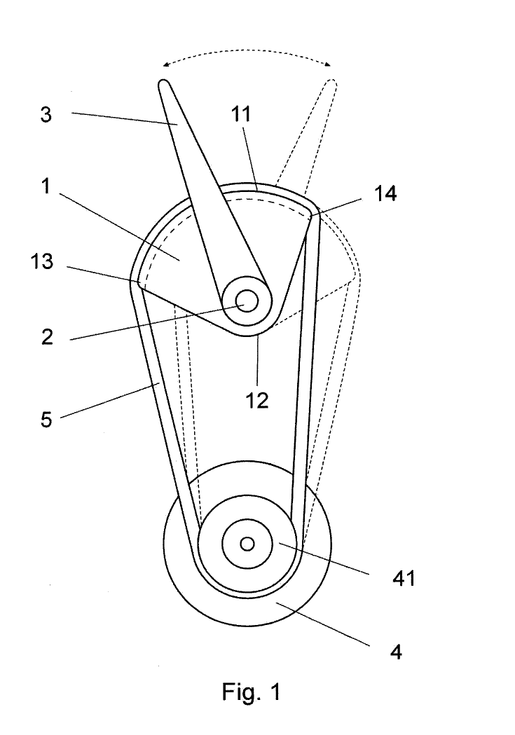

In the embodiment shown in FIG. 1, the distributor comprises: an actuator element (1) in the form of a circular sector having an amplitude of less than 180 degrees, to which there is fixed by means of a rotating shaft (2) a trapdoor (3), and a drive motor (4) conveying to the actuator element (1) an alternating rotating movement, between two end positions, by means of a wheel (41) and the corresponding belt (5).

The actuator element (1) has in its curved profile (11) a groove for the guided support of the belt (5).

The rotating shaft (2), which is integral in the rotation with the actuator element (1) and with the trapdoor (2), is arranged at a point of the bisector of the circular sector defined by the actuator element (1) and close to the vertex or angle (12) of said actuator element.

The motor (4) is in charge of conveying an alternating rotating movement, with a determined amplitude, to the assembly formed by the actuator element (1), the rotating shaft (2) and the trapdoor (3) to cause its pivoting between two end positions in which said trapdoor (3) is arranged symmetrically with regard to the mid-plane (P) of the distributor, defined by the rotating shafts of the actuator element (1) and of the wheel (41) of the motor (4).

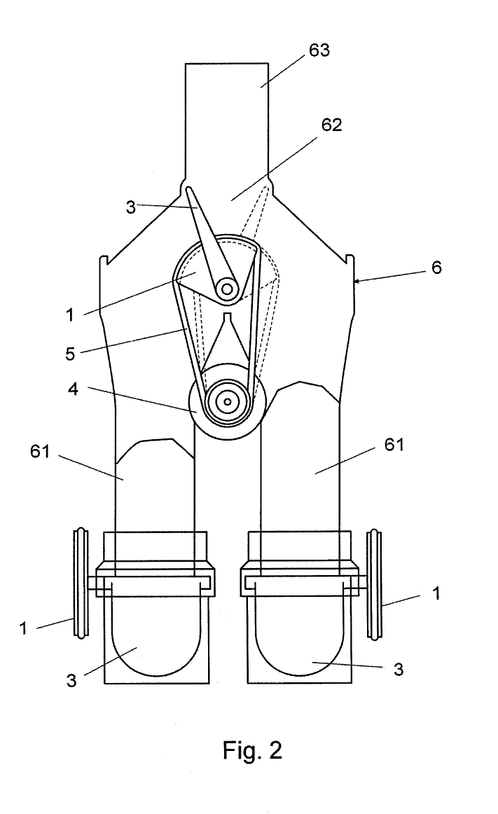

As previously mentioned and as can be observed in FIG. 2, this distributor is applicable in ground coffee dispensers (6) for industrial coffee makers.

In said FIG. 2, the dispenser (6), which is shown only by way of illustration, incorporates two distributors of the invention in the outlet ducts (61), and a third distributor of the invention in the convergence area (62) of said outlet ducts (61) with an inlet duct (63) for the ground coffee coming from a grinder.

In the end positions, the trapdoors (3), housed in the outlet ducts (61) of the dispenser, independently open and close said outlet ducts and, accordingly, retain or release the dispensed amount of ground coffee to be supplied.

In turn, in the end positions, the trapdoor (3) arranged in the convergence area (62) of the outlet ducts (61) determines in its end positions the passage of the successive dispensed amounts of the ground coffee coming from the inlet duct (63) towards either of the outlet ducts (61).

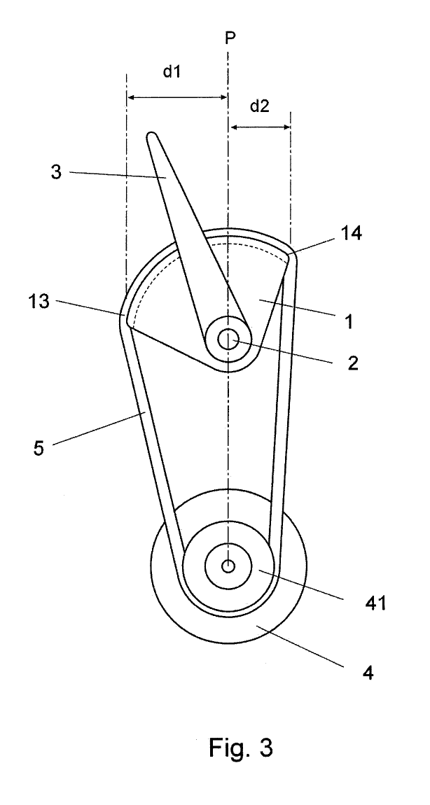

FIG. 3 depicts the actuator element (1) in a first end position. Due to the configuration of the actuator element (1), in the form of a circular sector, when the motor (4) causes the rotation of the actuator element (1) towards said first end position depicted in FIG. 3, there is a variation of the distances (d1 and d2) existing between the mid-plane (P) of the distributor and the respective end support areas (13 and 14) for supporting the belt (5) on the actuator element (1), the actual tension of the belt (5) generating respective rotation torques, of opposite directions and different magnitudes due precisely to the greater length of the distance (d1), resulting in a rotation torque which tends to keep the actuator element in said first end position depicted in FIG. 3.

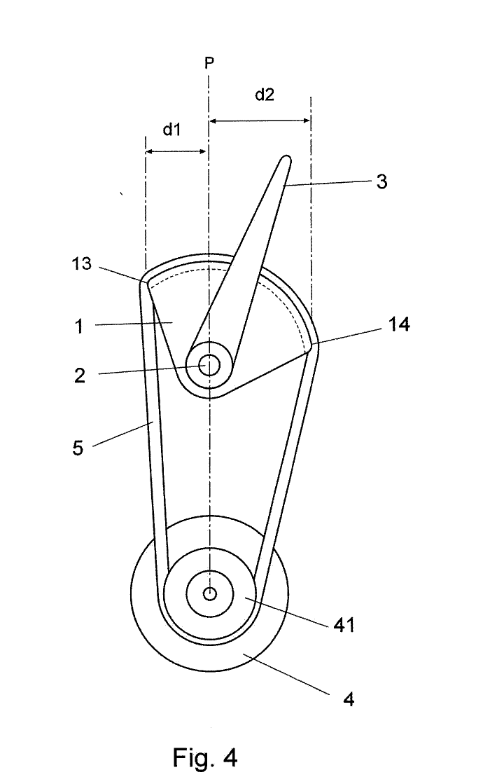

When the actuator element (1) is pivoted towards the second end position depicted in FIG. 4 by the action of the motor (4), the distance (d2) is greater than the distance (d1), the tension of the belt on the end support areas (13 and 14) for supporting the actuator element (1) causing two opposite rotation torques of different magnitudes, the result of which is a rotation torque which tends to keep the actuator element (1) in said second end position.

Therefore, the distributor assures a stable and effective arrangement of the actuator element (1) and of the trapdoor (3) in any of the end pivoted positions.

Having sufficiently described the nature of the invention as well as a preferred embodiment, it is hereby stated for all suitable purposes that the materials, shape, size and arrangement of the described elements could be modified provided that this does not involve an alteration of the essential features of the invention that are claimed below.

1. Distributor for ground coffee dispensers, especially designed to be applied in ground coffee dispensers located at the outlet of coffee grinders for the purpose of achieving an automatic dispensing of ground coffee in different amounts and/or in different outlets; said distributor being of the type of those comprising: a swinging trapdoor for the temporary retention of the dispensed amount of ground coffee inside an outlet duct, or the deviation of the dispensed amount of ground coffee towards two optional outlet ducts, an actuator element associated with the rotating shaft of the swinging trapdoor and able to rotate between two angular end positions, and a motor conveying to the mentioned actuator element a rotating movement with a determined amplitude by means of a wheel and the corresponding belt or element for conveying the rotating movement;
wherein the mentioned actuator element has a configuration in the form of a circular sector, having an amplitude equal to or less than 180°, the rotating shaft of which is located in correspondence with a point of the bisector close to the angle or vertex of said circular sector; the curved profile of the actuator element forming a support surface for supporting the belt for conveying the rotating movement of the motor and the rotation of the actuator element towards any one of the angular end positions determining a variation of the distances (d1, d2) existing between the mid-plane (P) of the distributor, defined by the rotating shafts of the actuator element and of the wheel, and the respective end support areas for supporting the belt on the actuator element; the tension of the belt on said end support areas causing respective rotation torques, of opposite directions and different magnitudes, resulting in a rotation torque which tends to effectively keep the actuator element in the chosen end position.

2. A distributor for ground coffee dispensers according to claim 1, wherein the belt for conveying the rotating movement is formed from an elastic material.
